(19) United States
(12) Patent Application Publication
(10) Pub. No.: US 2014/0144470 A1
(43) Pub. Date: May 29, 2014

(54) SYSTEM FOR MANIPULATING OBJECTS

(71) Applicants: Paul Anthony Sewell, Warrnambool (AU); David Gerard Nelson, Warrnambool (AU); Phillip John Crouch, Ballarat (AU); Carmine Polzella, Box Hill North (AU); Clyde Campbell, Silverwater (AU); Victor Martchenko, Tullamarine (AU); Marcus Fridenberg, Ferntree Gully (AU)

(72) Inventors: Paul Anthony Sewell, Warrnambool (AU); David Gerard Nelson, Warrnambool (AU); Phillip John Crouch, Ballarat (AU); Carmine Polzella, Box Hill North (AU); Clyde Campbell, Silverwater (AU); Victor Martchenko, Tullamarine (AU); Marcus Fridenberg, Ferntree Gully (AU)

(73) Assignee: F.B. TECHNOLOGIES PTY LTD, Warrnambool, Victoria (AU)

(21) Appl. No.: 13/700,027

(22) PCT Filed: May 20, 2011
(86) PCT No.: PCT/AU11/00593

§ 371 Date: Jun. 3, 2013

(30) Foreign Application Priority Data
May 24, 2010 (US) 61347607
Aug. 20, 2010 (US) 61375440
Feb. 7, 2011 (US) 61440217

(51) Int. Cl. B25J 9/16; B08B 9/08; B08B 9/44

(52) U.S. Cl. CPC B25J 9/1664; B08B 9/44; B08B 9/0826; Y10S 901/02
USPC 134/18; 134/56 R; 700/245; 414/800; 700/258; 901/2

(57) ABSTRACT

A system for manipulating objects includes a scanner arranged to optically scan an object in a first position to obtain position data indicative of the first position, a manipulation module arranged to receive the position data and to generate orientation instructions therefrom for reorienting a manipulation arm from a first orientation corresponding to engagement of the object by the arm when the object is in the first position to a second orientation corresponding to engagement of the object by the arm when the object is in a second position, and an arm controller arranged to receive the orientation instructions and to control the manipulation arm to manipulate the object from the first position to the second position based on the orientation instructions.

### FIELD

This invention relates a system for manipulating objects. The present invention is of particular, though not exclusive, application in manipulating objects such as bins using a mobile bin cleaning apparatus.

The invention also relates to an ozonation system and method. Particularly, although not exclusive, application in transferring ozone gas into a liquid such as water.

### BACKGROUND

Hitherto, manipulation of many objects has been performed, at least industrially, using some form of mechanical arm configured to manipulate the object. For example, the arm may be configured in a factory environment to move an object that is always located in one predefined position to another predefined position. Alternatively, the arm may be operated manually by an operator to locate the object in one position and subsequently manipulate the object. This method of manually manipulating an object can be exemplified in the known methods of manipulating bins for cleaning.

For example, mobile bin cleaning has been typically performed manually by an operator using a mobile bin cleaning apparatus, such as a pressurised spray gun. In some cases, the bin has been located in a cleaning chamber of a mobile bin cleaning apparatus to contain and collect any sprayed fluid.

Generally, these bin cleaning chambers and cleaning mechanisms (e.g. spray guns) are moved between physical locations of bins by a vehicle. For example, the bin cleaning chamber may be incorporated into a trailer which is towed by a vehicle so that the operator can drive the vehicle and locate it near one or more bins to be cleaned. Once the trailer is in position, the operator can either physically move the bin into a position in which it can be cleaned or operate a moving mechanism, such as a gantry crane, to engage the bin and move it into a position to be cleaned. In both cases, the operator is required to manually locate the bin and move it, or arrange for it to be moved, to a desired position so that it can be cleaned using the cleaning mechanism.

An existing ozonation system uses an ozone contact chamber to transfer ozone gas, which is infused or injected, into a liquid such as water. This can be achieved using bubble diffuser contactors, direct injection methods, and/or turbine mixers. Bubble diffuser contactors do not require additional energy to operate and have high ozone transfer rates, but are typically constructed with 5 to 7 metre water depths to provide enough contact area for the ozone gas bubbles and the rate of ozone gas transfer into the water is relatively low. Injector contacting typically has a faster transfer rate as ozone gas is injected into a water stream under negative pressure. However, high concentration ozonised liquid is difficult to produce with this method as concentration is constricted by a maximum ozone gas to water transfer ratio. A turbine mixer can be used to mix ozone gas with water in a tank but, as with the bubble diffusion contact chamber, turbine mixing tanks require large water depths of up to 5 metres to provide sufficient contact area with the ozone gas bubbles and the ozone gas transfer rate is also relative low.

### SUMMARY OF THE INVENTION

According to a first aspect of the present invention there is provided an arm controller for controlling an arm, wherein the arm controller is arranged to:

receive information from a scanner indicative of a position or a profile of an object in a first position; and

control the arm based on the received information from the scanner to engage the object in the first position and to move the object from the first position to a second position.

According to another aspect of the present invention there is provided a system for manipulating objects comprising:

a scanner arranged to optically scan an object in a first position to obtain position data indicative of said first position;

a manipulation module arranged to receive the position data and to generate orientation instructions therefrom for reorienting a manipulation arm from a first orientation corresponding to engagement of said object by said arm when said object is in said first position to a second orientation corresponding to engagement of said object by said arm when said object is in a second position; and

an arm controller arranged to receive the orientation instructions and to control the manipulation arm to manipulate the object from the first position to the second position based on the orientation instructions.

In an embodiment, the system further comprises a translation module arranged to receive said position data from the scanner, to transform said position data into a frame of reference relative to the system, and to output said position data once transformed to the manipulation module. In an example, the translation module is further arranged to transform the position data into three dimensional co-ordinate data (e.g. x, y and z co-ordinates) so that a three dimensional profile of the object in the frame of reference can be obtained. Alternatively, the translation module is arranged to translate the position data into polar co-ordinates.

In an embodiment, the second position is predefined. In the embodiment, the second position is determined, at least in part, according to an identification of the object.

In an embodiment, the system further comprises an identification module for identifying the object in the first position from the position data received from the scanner. In another arrangement, the object is identified by an operator.

In an embodiment, the identification module identifies the object from predefined patterns in the position data.

In an embodiment, the arm controller is further arranged to control the manipulation arm for translational manipulation of the object from the first position to the second position based on the orientation instructions. In another embodiment, the arm controller is further arranged to control the manipulation arm for rotational manipulation of the object from the first position to the second position based on the orientation instructions. It will be appreciated by those persons skilled in the art that the arm controller may be arranged to control the manipulation arm to manipulate the object from the first position to the second position and vice versa via rotational and/or translational manipulation.

In an embodiment, the manipulation arm comprises a gripper at one end to retain the object to the manipulation arm. In an example, the gripper is arranged to rotate the object.

In an embodiment, the system further comprises an operating module arranged to perform an operation associated with the object in the second position.

In an embodiment, the object comprises a receptacle. In an arrangement, the receptacle comprises a bin. In another arrangement, the operating module comprises a cleaning module to clean the bin. In yet another arrangement, the receptacle comprises a bomb and the operating module comprises a bomb disposal module to dispose of the bomb.

In an embodiment, the system comprises a mobile apparatus comprising the scanner, the manipulation module and the arm controller (e.g. a vehicle).

In an example, the object comprises an injured person. In this example, the system can be used to retrieve the injured person by locating a stretcher at one end of the manipulation arm underneath the injured person in the first position based on the received position data so that the injured person can subsequently be moved to the second position. Furthermore, it will be appreciated by those persons skilled in the art that the system may be disposed on a mobile apparatus for retrieval of the injured person and the mobile apparatus may be an unmanned vehicle so that the retrieval of the injured person can be fully automated.

According to another aspect of the present invention there is provided a method of manipulating objects comprising:

optically scanning, by a scanner, an object in a first position to obtain position data indicative of said first position;

generating orientation instructions from said position data for reorienting a manipulation arm from a first orientation corresponding to engagement of said object by said arm when said object is in said first position to a second orientation corresponding to engagement of said object by said arm when said object is in a second position; and

controlling the manipulation arm to manipulate the object from the first to the second position based on the orientation instructions.

According to another aspect of the present invention there is provided a system for manipulating objects comprising:

a scanner arranged to optically scan an intended location to place an object in is a first position to obtain position data indicative of said first position;

a manipulation module arranged to receive the position data and to generate orientation instructions therefrom for reorienting a manipulation arm from a first orientation corresponding to engagement of said object by said arm when said object is in a second position to a second orientation corresponding to engagement of said object by said arm when said object is in said first position; and

an arm controller arranged to receive the orientation instructions and to control the manipulation arm to manipulate the object from the second position to the first position based on the orientation instructions.

In an example, the object is not located in the first position but is retained by the manipulation arm in the second position to be placed in the first position. For example, the first position comprises a shelf for storage of an object presently retained in the second position. In this example, the system can be used to scan the storage shelf to subsequently determine the intended location to place the object, such as a pallet or crate, on the storage shelf based on the received position data indicative of the first position from the scanner. In another example, the object is a receptacle arranged to receive ammunition. In this example, a mobile apparatus, as described above, could be located adjacent an intended location of ammunition in the first position (e.g. on the battle field or within an ammunition hold of a plane) and the intended location can be scanned by the scanner to subsequently generate orientation instructions to manipulate the arm and place the ammunition in the first position. In another example, the object is a receptacle arranged to receive a payload of paint. Similarly, a mobile apparatus could be located adjacent the intended location of the paint in the first position (e.g. on a road) and the intended location can be scanned by the scanner to generate orientation instructions to manipulate the arm to release the paint in the first position. In yet another example, the receptacle is used to receive medical equipment, such as surgical tools. In this case, the surgical tools can be used in the first position based on the position data received from the scanner.

It will be appreciated by those skilled in the art that the above described system and method of manipulating objects can be exemplified in a system and method of manipulating bins for cleaning.

According to another aspect of the present invention there is provided a mobile bin cleaning apparatus comprising:

a cleaning module disposed in the mobile bin cleaning apparatus to clean a bin;

an arm arranged to move the bin between a first position remote from the mobile bin cleaning apparatus and a second position in which the bin can be cleaned by the cleaning module;

at least one scanner arranged to scan the bin in the first position to determine a position of the bin relative to the mobile bin cleaning apparatus; and

an arm controller arranged to control the arm to retain the bin and move the bin between the first and second positions based on the position determined by the at least one scanner.

In an embodiment, the arm is an articulated robotic arm. In an example, the arm comprises a tool at one end. In an arrangement, the tool comprises a gripper to retain the object thereto with an engagement means. In one arrangement, the engagement means comprises at least one suction cap and in other arrangement the engagement means comprises at least one claw. For example, the claw includes pneumatic or hydraulic operated arms to retain various shaped objects (e.g. bins, bombs, stretchers, etc.) of varying weight and dimensions.

In an example, the articulated robotic arm includes the gripper at one end to retain the bin thereto. It will be appreciated by those skilled in the art that the gripper is arranged to grip and thus retain the bin to the arm, but may also engage the bin (e.g. by engaging pre-arranged slots on the bin) to retain the bin whilst it is moved between positions. Also, it will be appreciated that, at the opposed end to the gripper end of the robotic arm, the robotic arm is fixed to the mobile bin cleaning apparatus so that the bin can be moved between a position remote from the mobile bin cleaning apparatus (e.g. on a curb side of a road) and a second position in which the bin can be cleaned by the cleaning module disposed in the bin cleaning apparatus.

In an embodiment, the gripper includes at least one suction cap. In an arrangement, the or each suction cap comprises a vacuum means arranged to apply a suction force to a surface of the bin to retain the bin thereto. It will be appreciated by those skilled in the art that the mobile bin cleaning apparatus includes an air pump, or similar, to create a partial vacuum in the or each suction cap. In another arrangement, the or each suction cap comprises a bellow type suction cap which allows for a greater vacuum force to be imparted on the surface of the bin. In a further arrangement, the gripper includes one central bellow type suction cap flanked by two heavy duty suction caps so that the central bellow type suction cap can draw the bin into the two heavy duty suction caps to better retain the bin.

In an embodiment, the gripper is arranged to pivot about a fulcrum connected to the articulated robotic arm. In this way, the gripper can be operated to retain and move the bin from different orientations, such as when the bin is upright, or on its side, etc. For example, if the arm is used to move a bin lying on its side, the gripper can be suitably configured to retain the bin, and the gripper and the bin can then pivot about the fulcrum as they are moved between the first and second positions.

In an embodiment, the arm controller is arranged to rotate the gripper about a shoulder connected to the articulated robotic arm. The gripper is then rotated into a suitable configuration to retain the bin in its current orientation (e.g. upright, or lying on it side, etc). Thus, in an example, the arm controller controls the arm via the shoulder to configure the gripper to retain the bin, and controls the arm to move the bin between the first and second positions based on the position determined by the at least one scanner.

In an embodiment, the articulated robotic arm includes six articulation joints to move the bin between the first and second positions. It will be appreciated by those skilled in the art that the number of articulation joints of the arm may be more or less depending on the size, configuration, distance from the mobile cleaning apparatus, and general orientation of the bins to be moved and cleaned. Also, it will be appreciated by those skilled in the art that the articulated lengths of the arm may also vary in size depending on the application.

In an embodiment, the scanner obtains position data in the form of distance values relative to the scanner from a surface of the object in the first position at predetermined vertical intervals. In the embodiment, the scanner scans horizontally along a surface of the object to obtain a number of distance values across the x axis, and these distance values form the z axis values. In an arrangement, the scanner scans horizontally at different y axis values, given by the predetermined vertical interval, in a single sweep or motion. Thus, the scanner obtains position data that can be transformed by the translation module into a frame of reference comprising x, y and z co-ordinates relative to the mobile apparatus.

In an embodiment, the scanner comprises a laser scanner. In an example, the laser scanner is a SICK™ laser scanner.

In an embodiment, the scanner scans at an angle relative to a right angle. In an arrangement, the angle is between 1 and 45 degrees from the perpendicular extending from the mobile apparatus. In another arrangement the angle is 15 degrees from the perpendicular extending from the mobile apparatus.

In an embodiment, the scanner comprises two spaced apart scanners to obtain a greater number of distance values to form a three dimensional profile of the object defined by x, y and z co-ordinates. In yet another arrangement, the two scanners scan at opposed 15 degree angles to the perpendicular to better determine the three-dimensional profile of the object in the first position.

In an embodiment, the scanner determines a three-dimensional profile of the bin relative to the mobile bin cleaning apparatus.

In an embodiment, the arm controller is arranged to control the arm to retain the bin and move the bin based on the determined three-dimensional profile of the bin. For example, the scanner scans the bin in the first position to determine its three-dimensional profile (e.g. the bin's shape and orientation relative to the mobile bin cleaning apparatus) so that the gripper can retain the bin and subsequently move the bin from the first position to the second position. In the example, the arm controller determines a suitable surface of the bin for the gripper to retain the bin, configures the gripper to retain the bin, and controls the movement of the articulation joints of the arm to move the retained bin from the first position to the second position so that it can be cleaned by the cleaning module. The arm controller then controls the arm to subsequently return the bin to the first position and release the bin based on the determined profile. It is envisaged that if the bin in determined to be in an undesired orientation (e.g. lying on its side on the ground), it will be returned to the first position in a desired orientation (e.g. upright) at a predetermined position relative to the mobile bin cleaning apparatus.

In another example, the scanner scans the bin in the first position and obtains position data for the identification module to identify the bin. In the example, the identification module identifies the bin by first determining the location of the wheels and the front panel of the bin from the scanned position data. It will be appreciated by those persons skilled in the art that the size and location of the wheels relative to the size and location of the front panel is known for standard sizes of bins. In this way, processing time and resources can be reduced for scanning bins of known sizes. The location of the wheels and the front panel of the bin can then be used to determine the orientation of the bin and its size. In addition, as the sizes of bins are generally standardised, the three dimensional profile of the bin can be completed by the translation module using known profiles of bins.

In another example, the scanner scans the environment in the field of view surrounding the bin to determine if an obstacle (e.g. a person) is located and/or has entered the area immediately surrounding the bin whilst scanning the bin. If so, an alert is provided to an operator and an operation, such as moving the bin, can be suspended pending action of the operator. In an example, the system comprises an additional scanner designated to scan the environment surrounding the bin for intruders or obstacles.

In an embodiment, the mobile apparatus comprises a control panel for an operator to control and/or monitor manipulating objects and subsequently performing an operation on an object (e.g. a bin). In an example, the control panel enables an operator to control the operation of cleaning bins from the cabin of the mobile apparatus by first prompting the operator to confirm the size of the bin to be scanned, to confirm that the scan of the bin was correct, and that there are no obstacles in the area surrounding the bin. Furthermore, the control panel displays a view of the first position from the side of the mobile apparatus to the operator using a camera mounted on the mobile apparatus so that the operator can locate the mobile apparatus adjacent a bin from the driving position. In addition, the control panel is a touch screen for ease of operation. It will be appreciated by those persons skilled in the art that the control panel may be programmed to control various other operations, such as bomb disposal, as described above.

In the above described embodiment, the at least one scanner (i.e. the scanner) includes two spaced apart scanners to provide redundancy and to determine the three-dimensional profile of the bin. In an arrangement, each scanner includes a laser scanner arranged to emit a laser beam to be reflected off a surface of the bin at predetermined intervals. The reflected laser beams are then detected by the scanners to determine distance and thus position of the bin from the scanners.

In one example, the scanner is arranged to detect distance in one plane (e.g. horizontally) and thus determines a position of the bin relative to the scanner and the mobile bin cleaning apparatus. In another example, the scanner is arranged to detect distance in more than one plane and thus can determine the three-dimensional profile of the bin. In each example, the mobile bin cleaning apparatus can be used to move and clean bins of various profiles based on the outputted determined information from the or each scanner.

In an embodiment, the two spaced apart scanners are disposed in a movable track so that the scanners can be located approximately perpendicular to the bin to be scanned.

In an embodiment, the cleaning module comprises a cleaning chamber arranged to receive the bin at least partially therewithin in the second position. It will be appreciated by those skilled in the art that the cleaning module may comprise a cleaning instrument, such as a rotating brush, that does not require the bin to be received within the cleaning chamber.

In an embodiment, the cleaning module includes at least one spray nozzle for spraying cleaning fluid inside the bin. In an example, the at least one spray nozzle is a rotating spray nozzle to spray the inside surface of the bin. In another embodiment, the cleaning module includes a plurality of spray nozzles for spraying cleaning fluid outside the bin. In an arrangement, the spray nozzles for spraying cleaning fluid outside the bin are arranged circumferentially around the bin in a ring at designated intervals to clean the outside surface of the bin. In both cases, the cleaning chamber prevents sprayed cleaning fluid from escaping the cleaning module to environment.

It will be appreciated by those persons skilled in the art that the cleaning fluid may include water, or water mixed with a detergent and/or a disinfectant, or similar. However, it is also envisaged that other cleaning fluids may be employed depending on the application, such as oil based solvents.

In an embodiment, the cleaning chamber includes a sump to collect sprayed cleaning fluid therewithin. In an example, the sump is located at the lowest point of the cleaning chamber to collect the sprayed cleaning fluid from the spray nozzles.

In an embodiment, the cleaning module includes a filtering means to filter the collected sprayed cleaning fluid from the sump. For example, the sump collects the sprayed cleaning fluid and solid particles, such as any dirt, grime, or refuse previously stuck to the bin. The solid particles are filtered by the filtering means so that the cleaning fluid can be recovered and stored in a tank for re-use. In one example, the filtering means includes a centrifugal filter to remove solid particles from the collected sprayed cleaning fluid. In another example, the filtering means includes a vibrational filter to remove these solid particles, such as a vibrational sieve.

In an embodiment, the cleaning module comprises an ozone generator arranged to generate ozone to be mixed in with the cleaning fluid (or water) for spraying inside and/or outside the bin. In the embodiment, the ozone generator generates ozone as a disinfectant to disinfect the bin and the stored recycled (i.e. filtered) fluid. It would be appreciated by those skilled in the art that other sanitising agents may be employed by the apparatus, such as chlorine and bromine.

In an embodiment, the mobile bin cleaning apparatus includes a vehicle. In the embodiment, the vehicle is a truck with a cabin for a driver to operate the truck and a tray incorporating the mobile bin cleaning apparatus. In an alternative embodiment, the mobile bin cleaning apparatus is disposed in a trailer attached to the vehicle (e.g. the truck).

According to another aspect of the present invention there is provided a method for cleaning bins comprising:

locating a mobile bin cleaning apparatus adjacent a bin in a first position;

scanning the bin in the first position to determine a position of the bin relative to the mobile bin cleaning apparatus;

outputting determined position information of the bin to an arm controller;

controlling an arm, by the arm controller, to move the bin from the first position to a second position in which the bin can be cleaned in a cleaning module disposed in the mobile bin cleaning apparatus based on the determined position information of the bin;

cleaning the bin by the bin cleaning module; and

controlling the arm, by the arm controller, to move the bin from the second position to a position remote from the mobile bin cleaning apparatus.

It will be appreciated by those skilled in the art that the above described ozone generator is an exemplified embodiment of a system and method of ozonation.

According to one aspect of the present invention there is provided an ozonation system, comprising:

an ozone source for providing ozone gas for transfer into a liquid;

a tank for retaining the liquid therein and having an inlet and an outlet for admitting said liquid into the tank and releasing said liquid from the tank, respectively;

an ozone injector for injecting said ozone gas received from the ozone source into an influent stream of said liquid received from said tank via the outlet; and

an ozone contact chamber for receiving said influent stream with said ozone gas, contacting said ozone gas with the liquid of said influent stream so that the ozone gas is transferred into the liquid, and outputting said liquid from the contact chamber with said ozone gas transferred therein into an effluent stream to be returned to the tank via the inlet;

wherein the ozone contact chamber comprises a plurality of contact chamber portions through which said influent stream passes for successively generating turbulence.

In an embodiment, the plurality of contact chamber portions increases the residence time of the liquid in the contact chambers. In the embodiment, the contact chamber portions increase the contact area of the ozone gas within the liquid so that it can be more readily dissolved.

In an embodiment, the ozone gas and water pass through strategically positioned inline mixers designed to further reduce ozone gas bubble size whilst passing through the plurality of contact chamber portions through which the influent stream experiences high contact and/or residence time, ensuring adequate mixing and transfer of gas into the liquid (e.g. water). These inline or turbine mixers, or other mixing devices, when used with, for example, five metre sections of pipe forming the successive contact chamber portions (e.g. mixing coils) ensure that ozone gas bubble size is miniaturised, and hence transfer and contact rates of the gas with the water is maximised to achieve maximum ozone concentration in the water. In an arrangement, the inline mixers comprise mechanical mixing nozzles.

In an embodiment, the liquid comprises water and the ozone gas transferred into the water treats the water by oxidising organic and inorganic compounds in the water, thereby having a disinfecting effect on objects in contact with the ozonised water. It will be appreciated by those persons skilled in the art that a typical concentration of ozone gas dissolved in water for water treatment and use with respect to disinfecting objects is around 0.1 to 4 milligram per litre. Such ozonised water may be used, for example, to spray the inside and/or outside of a bin to clean and disinfect the bin, with the sprayed water returned to the tank for treatment and reuse. The ozonised water may also be used, for example, for vegetation spraying. In this case the ozonised water is used to spraying weeds, grass, etc. without leaving chemical residue in the soil.

In another example, the liquid is not water and is some other liquid suitable for absorbing ozone.

In an embodiment, the tank further comprises a further outlet for outputting the liquid having ozone gas transferred therein with respect to an object (e.g. a bin or a food crate). In the embodiment, the tank further comprises a further inlet for returning the outputted liquid after it has been used with respect to the object. Thus, in an example, ozonised water is pumped from the further outlet of the water tank to spray the inside and/or outside of a bin and the sprayed water is returned to the tank via the further inlet. It will be appreciated by those persons skilled in the art that ozonised water can be used to disinfect any surface, such as those within operating theatres, and can be used to treat and decontaminate water for consumption or industrial purposes, such as sewerage treatment and desalination. In addition, ozonised water can be used treat bacteria such as anthrax, mastitis, staphylococcus, cystic fibrosis, etc.

In an embodiment, the plurality of successive contact chamber portions comprises a plurality of elongate coils of pipe for successively generating turbulence. The pipe ensures a high degree of contact time by generating turbulence in the influent stream and, along with the use of mechanical mixing nozzles aimed at reducing bubble size of the ozone gas, ensures adequate ozone mass transfer in the water stream. In an arrangement, the plurality of elongate coils of pipe comprises 12 coils of pipe. In the arrangement, each coil of pipe comprises a length of 1500 mm. It will be appreciated by those skilled in the art that other arrangements of coils of pipe are envisaged to contact the ozone gas with the liquid contained therein, such as having more coils of pipe with shorter lengths (e.g. 20 coils of pipe with lengths of 1000 mm).

It will also be appreciated by those skilled in the art that the diameter of the pipe is designated based on the size of the tank, the amount of ozonised liquid required for the application, the desired concentration of ozone gas in the liquid, and the desired transfer rate of ozone gas into the liquid.

In an embodiment, the plurality of elongate coils of pipe are vertically orientated within the system. For example, the injected ozone gas within the influent stream is received by the contact chamber and forced vertically into a first coil of the contact chamber in a turbulent flow to reduce bubble size of the ozone gas and increase its contact area for greater transfer into the liquid. The influent flow is then forced downward vertically, assisted by gravity, in the second coil further reducing bubble size, and this process is repeated for the elongate portions of the coils. That is, the action of forcing the influent stream vertically enhances turbidity and thus improves mixing of the gas, whose bubble size may have been previously miniaturised through the action of the strategically positioned mechanical mixing devices (e.g. inline mixers) so as to ensure adequate reduction in bubble size.

In an embodiment, at least one of the plurality of elongate coils of pipe comprises an inline mixer for further reducing bubble size of the ozone gas. In this case, the mixer further increases turbulence in the influent stream thereby further reducing the bubble size of the ozone gas for greater transfer into the liquid. In an arrangement, there are three inline mixers disposed on the 12 coils of pipe. It will be appreciated by those persons skilled in the art that inline mixer may include a rotary blade arranged to draw in the influent stream, containing liquid and ozone gas bubbles, and apply a centrifugal force thereto to force the influent stream into a coil of pipe. Also, the inline mixer may contain a perforated stator to further increase turbidity.

In an embodiment, the system further comprises a pump arranged to receive the influent stream of the liquid from the tank via the outlet. In an arrangement, the pump is a recirculation pump that both forces liquid from the tank into the contact chamber and forces liquid from the contact chamber back into the tank.

In an embodiment, the ozone injector comprises a venturi valve arranged to inject the ozone gas into the pressurised influent stream of the liquid. In an example, the pressurised influent stream causes a vacuum on the venturi valve and ozone gas is thus injected into the influent stream under negative pressure. In another embodiment, the ozone gas may also be pumped to the ozone injector.

In an embodiment, the tank comprises a mechanical mixing nozzle used or turbine for mixing the liquid in the tank. The action of the turbine creates turbulence in the tank to enhance transfer of ozone gas into the liquid and prevents the ozone gas transferred into the liquid from being released to an air gap above the liquid line in the tank and ultimately to atmosphere. In an embodiment, the tank is generally sealed from atmosphere to prevent ozone gas being released into the atmosphere and the air gap above the liquid line in the tank is minimised by recycling any ozonised liquid used with respect to an object (e.g. cleaning a bin).

In an embodiment, the ozone source comprises an ozone generator for generating ozone gas for transfer into the liquid. In the embodiment, the ozone generator comprises a corona discharge chamber for forming the ozone gas from received air. It will be appreciated by those persons skilled in the art that ozone gas is formed by the corona discharge chamber by combining an oxygen atom with an oxygen molecule (O₂): 3O₂⇄2O₃, and this reaction is endothermic. The received air, containing the oxygen, is passed through a discharge gap between two electrodes of the corona discharge chamber and oxygen molecules in the air are disassociated to form ozone gas. In an alternative embodiment, the ozone generator comprises a different ozone generation system such as an electrolytic reaction or UV light irradiation of air.

In an embodiment, the ozone generator comprises an oxygen concentrator for concentrating oxygen content in air to be received by the corona discharge chamber. In another embodiment, the oxygen generator comprises an air conditioner for cooling air to be received by the corona discharge chamber, thereby increasing oxygen content in air. It will be appreciated by those persons skilled in the art that the corona discharge chamber is more efficient at generated ozone gas from oxygen enriched air.

In an embodiment, the system further comprises a controller arranged to control an amount of ozone gas generated by the ozone generator based on data indicative of a concentration of the ozone gas transferred into the liquid in the tank received from sensor disposed in the tank. In the embodiment, the sensor comprises an oxidisation reduction potential (ORP) sensor arranged to measure dissolved oxygen content in the liquid which, in turn, is correlated to ozone content. In another embodiment, the sensor measures oxygen reduction potential which is correlated to ozone content directly in the liquid. In another embodiment, the controller controls pump flow from the pump, injection rate, and the flow rates of the influent and effluent streams. Furthermore, the controller monitors liquid levels in the tank so that the tank can be topped up with more liquid for continued operation.

In an embodiment, the system further comprises a mobile apparatus comprising the ozone source (e.g. ozone generator), the ozone injector, the ozone contact chamber and the tank. In the embodiment, the mobile apparatus comprises a vehicle. For example, the vehicle is a truck with a cabin for a driver to operate the truck and a tray incorporating the ozone generator, the ozone injector, the ozone contact chamber and the tank. In another example, the ozone source (e.g. ozone generator), the ozone injector, the ozone contact chamber and the tank are disposed in a trailer attached to the vehicle (e.g. the truck).

According to another aspect of the present invention, there is provided a mobile ozonation system comprising an ozonation system as described above.

In an embodiment, the mobile ozonation system comprises a moveable structure, wherein said ozonation system is mounted to said moveable structure.

In an embodiment, the moveable structure comprises one of a chassis, trailer frame, and a container.

According to another aspect of the present invention, there is provided a method of ozonation, comprising:

providing ozone gas for transfer into a liquid retained within a tank;

injecting said ozone gas into an influent stream of said liquid received from the tank;

receiving said influent stream with said ozone gas at an ozone contact chamber;

contacting said ozone gas with the liquid of said influent stream in the ozone contact chamber so that the ozone gas is transferred into the liquid using a plurality of successive contact chamber portions through which said influent stream passes for successively generating turbulence in the liquid in the contact chamber portions; and

outputting said liquid with said ozone gas transferred therein from the ozone contact chamber into an effluent stream to be returned to the tank.

According to another aspect of the present invention there is provided computer program code which when executed implements the above described methods.

### BRIEF DESCRIPTION OF THE DRAWINGS

In order that the invention can be more clearly ascertained, examples of embodiments will now be described with reference to the accompanying drawings wherein:

FIG. 1 is a schematic view of a mobile bin cleaning apparatus showing a bin in a first position remote from the mobile bin cleaning apparatus according to an embodiment of the present invention;

FIG. 2 is a schematic view of the mobile bin cleaning apparatus shown in FIG. 1 showing the bin in a second position in which the bin can be cleaned;

FIG. 3 is a side view of the mobile bin cleaning apparatus shown in FIG. 1;

FIG. 4 is a perspective view of a mobile bin cleaning apparatus according to an embodiment of the present invention;

FIG. 5 is a further perspective of the mobile bin cleaning apparatus shown in FIG. 4;

FIG. 6 is a perspective view of an arm arranged to retain and move a bin according to an embodiment of the present invention;

FIGS. 7a to 7c are perspective views of bins in different orientations according to exemplary embodiments of the present invention;

FIG. 8 is a perspective view of two spaced apart scanners arranged to scan a bin according to an embodiment of the present invention;

FIG. 9 is a perspective view of a cleaning module according to an embodiment of the present invention;

FIG. 10 is perspective view of a filtering means according to an embodiment of the present invention;

FIG. 11 is schematic view of an ozone generator according to an embodiment of the present invention showing an ozone contact chamber communicating influent and effluent streams from a tank;

FIG. 12 is a schematic view of a system for manipulating objects according to an embodiment of the present invention;

FIG. 13 is a flow chart of a method of manipulating objects using the system of FIG. 12;

FIG. 14 is a schematic view of an ozonation system according to an embodiment of the present invention;

FIG. 15 is a further schematic view of the ozonation system shown in FIG. 14;

FIG. 16 is a further schematic view of the ozonation system shown in FIG. 14; and

FIG. 17 is a flow chart of a method of ozonation using the system of FIG. 14.

### DETAILED DESCRIPTION

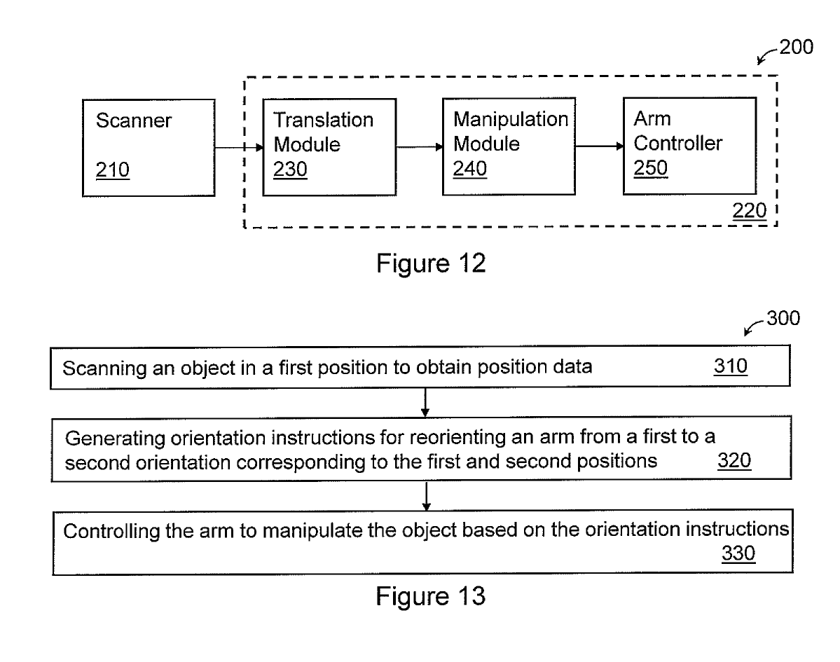

According to an embodiment, FIG. 12 shows a system 200 for manipulating objects comprising a scanner 210 arranged to optically scan an object in a first position to obtain position data indicative of the first position, and a processor 220 including a number of modules to implement the system 200 for manipulating objects (e.g. bins) from the first position to a second position.

The processor 220 includes a manipulation module 240 arranged to receive the position data from the scanner 210 and to generate orientation instructions from the position data for reorienting a manipulation arm (not shown in this Figure) between orientations to manipulate the object. That is, the manipulation module 240 generates instructions to reorient the manipulation arm from a first orientation corresponding to engagement of the object in the first position to a second orientation corresponding to engagement of the object in the second position. Furthermore, the processor 220 includes an arm controller 250 arranged to control the manipulation arm to manipulate the object based on these orientation instructions.

In addition, the processor 220 further includes a translation module 230 arranged to receive position data from the scanner 210, to transform the position data into a frame of reference relative to the system 200, and to output the position data once transformed to the manipulation module 240. The frame of reference further includes a representation of the object in the first position in three dimensions (e.g. x, y and z co-ordinates) so that a three dimensional profile of the object in the frame of reference can be obtained. For example, an object in the form of a bin in the first position can be scanned by the scanner 210 to obtain a three dimensional profile of the bin and the three dimensional profile can be used to generate instructions to reorient the manipulation arm from a first orientation corresponding to engagement of the bin in the first position to a second orientation corresponding to engagement of the bin in the second position.

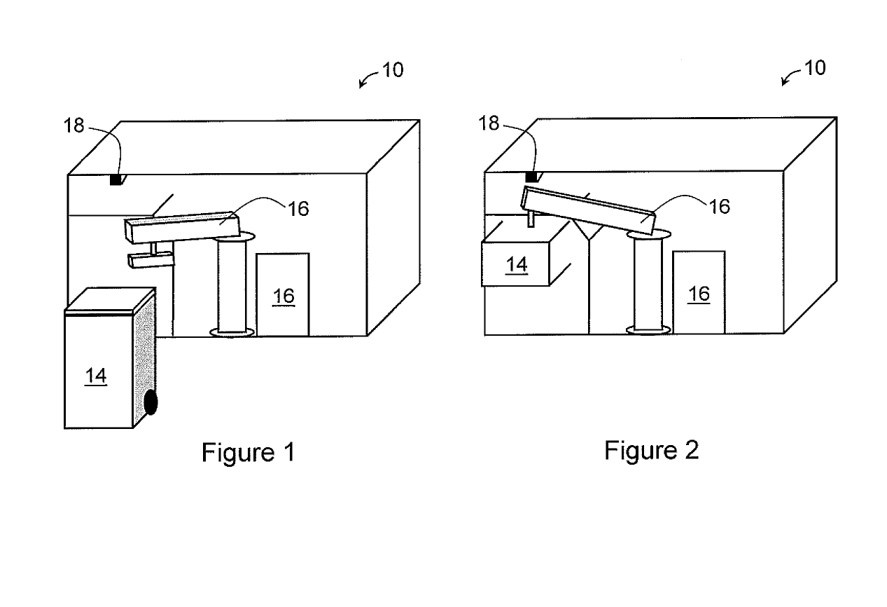

In the example described below, the system 200 is exemplified in a mobile bin cleaning apparatus (as shown in FIGS. 1 to 11). With reference to the example, the scanner 210 is arranged to optically scan the bin in the first position to obtain position data indicative of the first position. The translation module 230 then receives this position data from the scanner 210 and translates it into x, y and z co-ordinates relative to the mobile bin cleaning apparatus to form a three dimensional profile of the bin in the first position. These x, y and z co-ordinates of the bin are subsequently used by the manipulation module 240 to generate a sequence of orientation instructions for use by the arm controller 250 to control the manipulation arm. That is, the orientation instructions are used to reorient the arm between orientations corresponding to engaging the bin in the first and second positions. Furthermore, the manipulation module 240 generates further orientation instructions to reorient the arm from the second orientation to a further orientation to release the bin (e.g. on a footpath).

In addition, the arm includes a gripper at one end and the orientation instructions further include instructions relating to the orientation of the gripper to engage (e.g. retain) and release the bin.

As described, the bin is manipulated so that a cleaning operation can be performed on it. In the example, the system 200 includes an operating module (e.g. a cleaning module) to perform a cleaning operation on the bin in the second position, as shown in FIGS. 1 and 2. That is, FIGS. 1 and 2 show the system 200 disposed on a mobile apparatus in the form of a mobile bin cleaning apparatus 10 with a bin 14 being manipulated to move from a first position remote from the apparatus 10 shown in FIG. 1 to a predefined second position shown in FIG. 2 where the cleaning module 12 can clean the bin 14.

Thus, according to the exemplary embodiment, there is provided a mobile bin cleaning apparatus 10 including a cleaning module 12 disposed in the mobile bin cleaning apparatus 10 to clean a bin 14 which is located in a first position remote from the mobile bin apparatus 10, as shown in FIG. 1. As shown, the mobile bin cleaning apparatus 10 includes an arm 16 arranged to move the bin 14 between the first position and a second position in which the bin 14 can be cleaned by the cleaning module 12. In addition, the mobile bin cleaning apparatus 10 includes at least one scanner 18 to scan the bin 14, in the first position, to determine the position of the bin relative to the mobile bin cleaning apparatus 10, and an arm controller 20 arranged to control the arm 16 to move the bin 14 between the first and second positions based on the position determined by the scanner 18. Desirably, the bin 14 is retained by the arm 16 during the movement.

FIG. 2 shows the mobile bin cleaning apparatus 10 according to the embodiment where the bin 14 is in the second position, where it is to be cleaned by the cleaning module 12. Thus, in use, an operator locates the mobile bin cleaning apparatus 10 adjacent the bin 14 and the arm 16 is controlled, by the arm controller 20, to retain the bin 14 and move the bin 14 from the first position (remote from the mobile bin cleaning apparatus 10) to the second position (in which the bin can be cleaned) based on the determined position of the bin 14 outputted from the scanner 18. Subsequent to the bin 14 being cleaned, the arm 16 is controlled, by the arm controller 20, to move the bin 14 from the second position to return it to a position external of the mobile bin cleaning apparatus 10. Typically, this position is the first position but this is not essential. For example, the bin 14 may be returned to the opposed side of the mobile bin cleaning apparatus 10 so that dirty bins are located on one side and clean bins on the opposed side. In any event, the bin 14 is then released from the arm 16 so that the mobile bin cleaning apparatus 10 can be used to clean further bins.

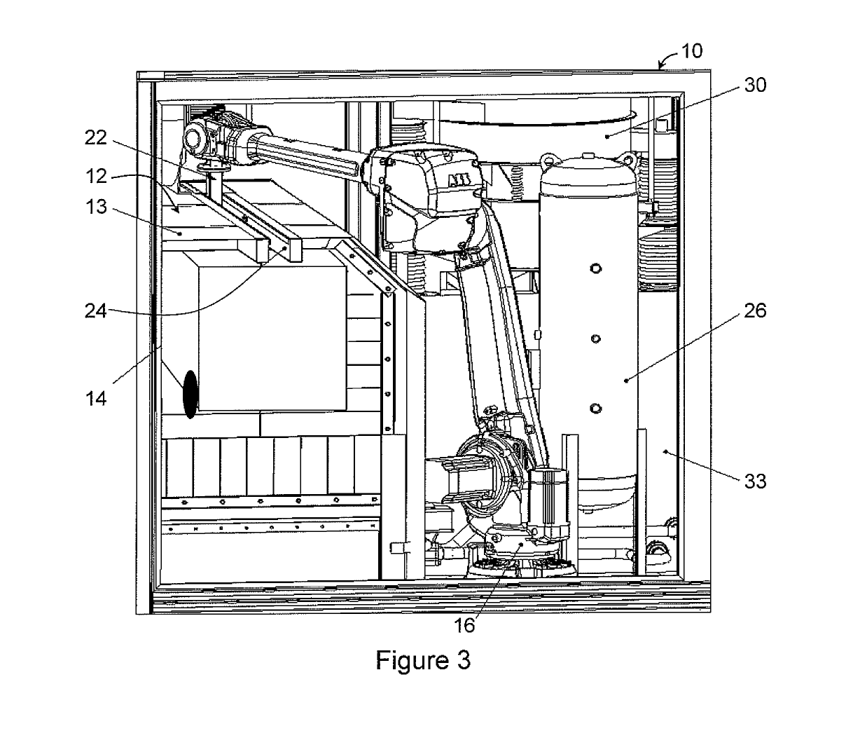

The arm 16 of the mobile bin cleaning apparatus 10 may retain the bin 14 using a gripper 22 which is disposed at one end of the arm 16 so that the bin 14 can be moved between the first and second positions, as shown in FIG. 3. In addition, the cleaning module 12 includes a cleaning chamber 13 arranged to receive the bin 14 at least partially therewithin whilst the bin 14 is being cleaned.

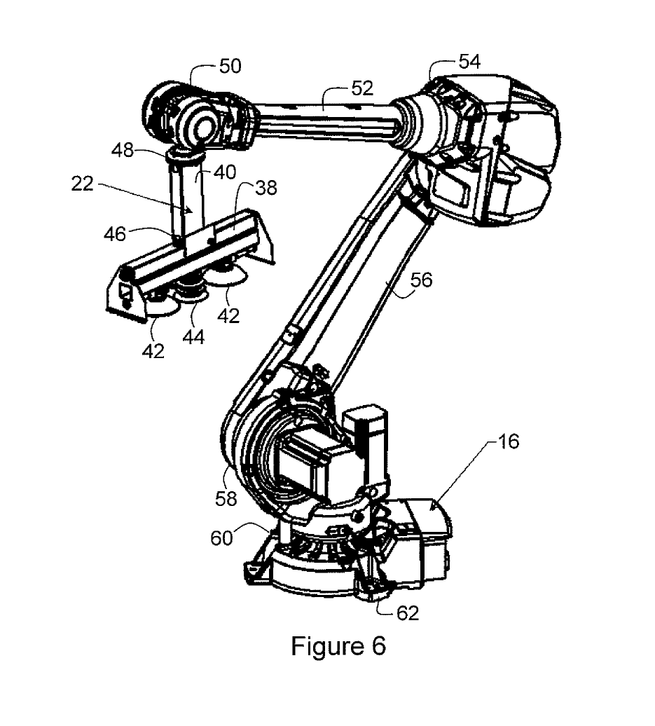

In an embodiment, the cleaning chamber 13 has an open slot 24 on its upper surface to allow the gripper 22 of the arm 16 to pass therethrough so the bin 14 can be moved in and out of the cleaning chamber 13. Also shown in FIG. 3 is an air receiver 26 for receiving air to generate a vacuum for suctions caps of the gripper 22, to be described with reference to FIG. 6.

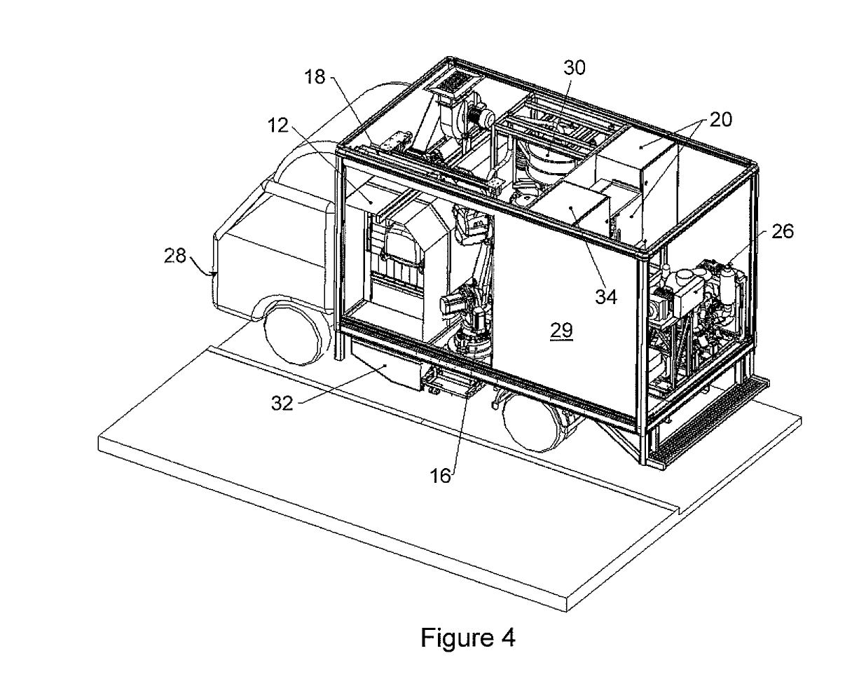

According to another embodiment of the present invention, a mobile bin cleaning apparatus 11 is disposed in a vehicle 28, as shown in FIG. 4. As described, the vehicle 28 may be a truck (as shown in FIG. 4), or the mobile bin cleaning apparatus may be disposed in a trailer to be towed by the vehicle 28. In any event, in use, the operator locates the vehicle 28 adjacent the bin 14 and then applies the brakes of the vehicle 28 so it can not move whilst bin cleaning.

In one example, the operator locates the vehicle 28 adjacent the bin 14 using a CCTV camera mounted to the mobile bin cleaning apparatus 11. In another example, the operator locates the vehicle 28 adjacent the bin 14 based on a position of the bin 14 determined by the scanner 18. In any case, once the vehicle 28 is located adjacent the bin 14, the scanner 18 scans the position of the bin 14 in the first position so that the arm 16 can be controlled, by the arm controller 20, to move the bin 14 between the first and second positions based on the determined position of the bin 14. The bin 14 may also be retained by the gripper 22 based on the determined position of the bin 14. Also, the mobile bin cleaning apparatus 11 includes a sliding door 29 arranged to be slid open when the mobile bin cleaning apparatus 11 is used to clean bins. For example, the operator drives the vehicle 28 with the sliding door 29 closed and locates the vehicle 28 adjacent the bin 14. The operator then operates the sliding door 29 to open the door and expose the cleaning module 12 and the arm 16 so that the bin 14 can be cleaned. The sliding door 29 can then be closed by the operator before driving the vehicle 28 to another location.

In addition, the operator controls the operation of the sliding door 29, and the operation of the arm 16 and the bin cleaning module 12 to clean bins using control panel (not shown) within a cab of the vehicle 28. In an example, the control panel is a touch screen.

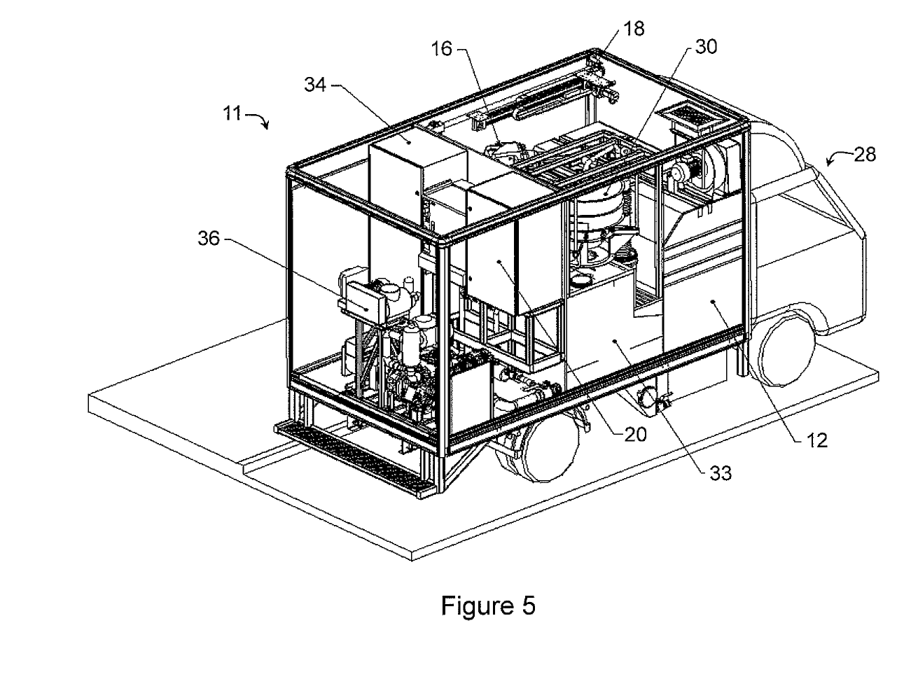

The mobile bin cleaning apparatus 11 also includes a sump 32 to collect sprayed cleaning fluid from the cleaning chamber 13. As described, the bin 14 is is cleaned by spraying cleaning fluid, which is stored in a tank 33, shown in FIG. 5, inside and/or outside the bin 14. The sprayed cleaning fluid is then collected by the sump 32 and filtered by a filtering means 30 so that it can be reused. Alternatively, the sprayed cleaning fluid collected from the sump 32 is filtered by the filtering means 30 before it is released into a storm water drain, or used for agriculture, etc. In the embodiment shown in FIG. 5, the filtering means 30 is located above the tank 33 so that the filtered fluid can pass into the tank 33 for use by the cleaning module 12.

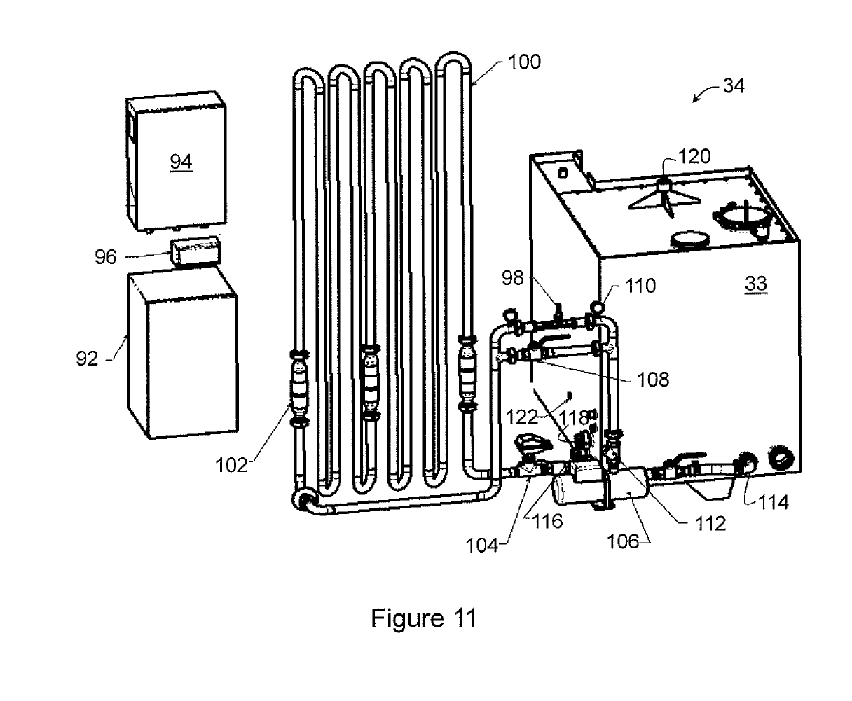

As described, the cleaning fluid further includes a sanitising agent, such as ozone to sanitise the bin 14 and the fluid stored in the tank 33. In the embodiment, the ozone is produced by an ozone generator 34 which includes components for generating ozone and mixing the generated ozone with the cleaning fluid, to be described with reference to FIG. 11.

It will be appreciated by those skilled in the art that some of the described components of the mobile cleaning apparatus 11 require power to operate. This power is supplied by a power plant 36 disposed in the mobile bin cleaning apparatus 11. In an arrangement shown in FIG. 5, the power plant 36 is a diesel generator capable of suppling power to all equipment at a desired voltage (e.g. 415V) however other sources of power are envisaged, such as batteries, photovoltaic cells, etc.

In an embodiment shown in FIG. 6, the arm 16 and the gripper 22 are shown in further detail. In the embodiment, the arm 16 is an articulated robotic arm and the gripper 22 includes heavy duty suction caps 42 to retain the bin 14 thereto. The gripper 22 also includes a bellow type suction cap 44 to further draw the bin 14 towards the heavy duty suction caps 42 to better retain the bin 14. The suction caps 42 & 44 include a vacuum means (not shown) to apply a suction force to a surface of the bin 14 to retain the bin 14 thereto. The vacuum means may be located remote from the arm 16 and pneumatic lines (not shown) are then deployed within the arm 16 to communicate the suction force to the suction caps 42 & 44. It is also envisaged that the air receiver 26 shown in FIG. 3 may be used to create a partial vacuum for the vacuum means. Also, the bellow type suction cap 44 protrudes beyond the heavy duty suctions caps 42 and has a number of folds to define a body of air that, in use, is removed by application of a suction force from the vacuum means thus drawing the bin 14 into the heavy duty suction caps 42.

In the embodiment shown in FIG. 6, the suctions caps 44 & 44 are arranged longitudinally along an elongate member 38. However, it will be appreciated by those skilled in the art that the elongate member 38 is used when the bin 14 typically has at least one elongate surface. Thus, for other shaped bins, different configurations of suction caps may be employed. For example, if a cubic shaped bin is to be generally cleaned by the mobile bin cleaning apparatus 11 then four suction caps may be arranged on a square shaped member 38 to retain the bin.

In another example, the arm controller 20 is further arranged to control the vacuum means (not shown) to stop providing a suction force when a vacuum can not be achieved. In this case, the arm controller 20 communicates with pressure sensors (not shown) arranged on the gripper 22 so that if a designated pressure can not be achieved, the arm controller 20 deems the bin 14 to have a crack in it an can not be retained. Thus, the arm controller 20 will stop providing a suction force to the gripper 22 and will then prompt the operator for further instructions. Also, the arm controller 20 may be further arranged to detect a load in the bin 14 via weight sensors (not shown) arranged on the arm 16. In this case, the sensors detect whether the bin 14 exceeds a designated weight and if so releases the bin 14. Furthermore, in a further example, the arm controller 20 may be arranged to receive an emergency stop command from the operator. If such a command is received, the arm controller 20 stops moving the bin 14, and/or providing suction to the bin 14, and/or cleaning the bin 14, depending on the current cycle of the mobile bin cleaning apparatus 11. In a still further example, the arm controller 20 may be operated manually by an operator to control the arm 16.

In the embodiment, the elongate member 38 is pivotally connected to an upright member 40 by a fulcrum 46 connected to the arm 16 so that, in use, the gripper 22 gripper can be operated by the arm controller 20 to retain and move the bin 14 located in different orientations in the first position. Also, in use, the arm controller 20 is arranged to rotate the gripper 22, about a shoulder 48 connected to the arm 16, into a suitable configuration to retain the bin 14 based on the determined orientation of the bin 14 (e.g. upright, or lying on it side, etc). In other words, the scanner 18 scans the position of the bin in the first position, and/or its profile, to determine an orientation of the bin 14 relative to the bin cleaning apparatus 11 so that the arm controller 20 can configure the gripper 22 into an optimum configuration to retain the bin 22 and move it into the second position.

Also, it can be seen in the embodiment shown in FIG. 6 that the arm 16 is articulated at a number of joints to retain and move the bin 14 between the first and second positions, which could be located in any orientation in the first position. The articulation joints are arranged to rotate 360° so that the articulated arm 16 can be operated through a number of different axes. In the embodiment, there are six articulation joints and thus the arm 16 can be operated through six distinct axes. The first articulation joint is the shoulder 48, which is connected to a second articulation joint 50 which, in turn, is connected to a telescopic arm 52 of the arm 16 to provide the arm 16 with greater reach to obtain and move bins located remote is from the mobile bin cleaning apparatus 11. The telescopic arm 52 can also be rotated at a third articulation joint 54, which, in turn, is connected to a swing arm 56 which can be rotated about a fourth articulation joint (not shown). The swing arm 56 can also be rotated by a fifth articulation joint 60 which, in turn, is fixed to a base 62 via a sixth articulation joint 60.

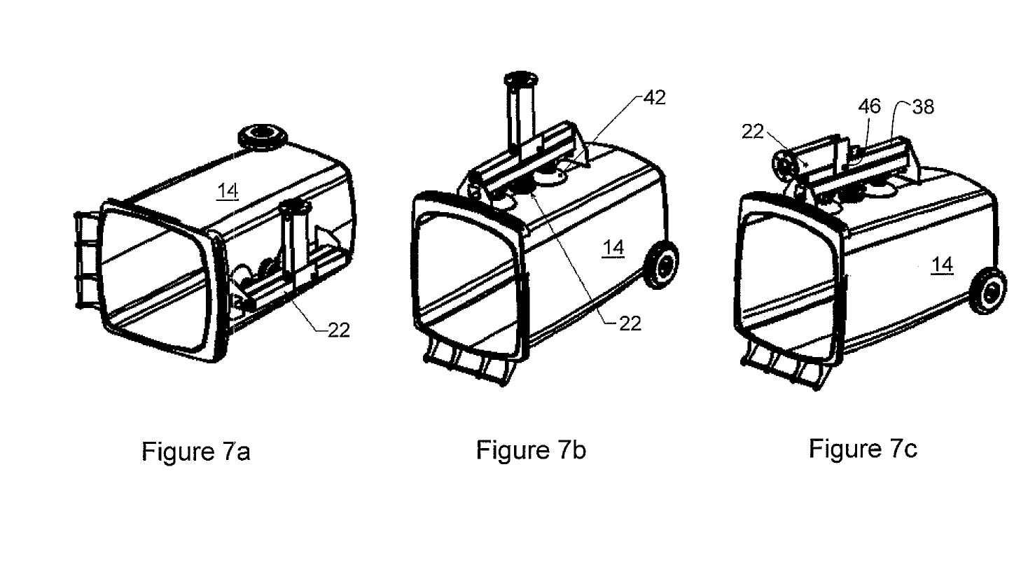

As described, the gripper 22 can be used in different configurations to retain the bin 14 located in different orientations. In a first example, the bin 14 is lying on its side in the first position, as shown in FIG. 7a, and the bin cleaning module 12 is arranged to clean the bin 14 with its front side face up when in the second position. In this example, the scanner 18 scans the bin to determine its position and arm controller 20 is arranged to control the gripper 22 to locate the elongate member 38 of the gripper 22 along the front side surface of the bin 14 based on the determined position and orientation of the bin 14. Once in position, the arm controller 20 controls the gripper 22 to apply a suction force via the suction caps 42 & 44 to retain the bin 14 thereto before moving the bin 14 to the second position to be cleaned.

In a second example, the bin 14 is lying on its back so the front surface is facing upwards, as shown in FIG. 7b. In this example, the arm controller 20 is also arranged to control the gripper 22 to locate the elongate member 38 of the gripper 22 along the front side surface of the bin 14 based on the determined position and orientation of the bin 14, then to apply a suction force via the suction caps 42 & 44 to retain the bin 14 before moving the bin 14 to the second position to be cleaned.

In a third example shown in FIG. 7c, the bin 14 is also lying on its back, as in FIG. 7b, but is located further away from the mobile bin cleaning apparatus 11. Thus, to obtain greater reach, the arm controller 20 is arranged to located the elongate member 38 of the gripper 22 along the front side surface of the bin 14 but with the upright member 40 of the gripper 22 being rotated about the fulcrum 46 to lie substantially parallel with the elongate member 38. The bin 14 is then retained by applying a suction force and moved to the second position to be cleaned as described above.

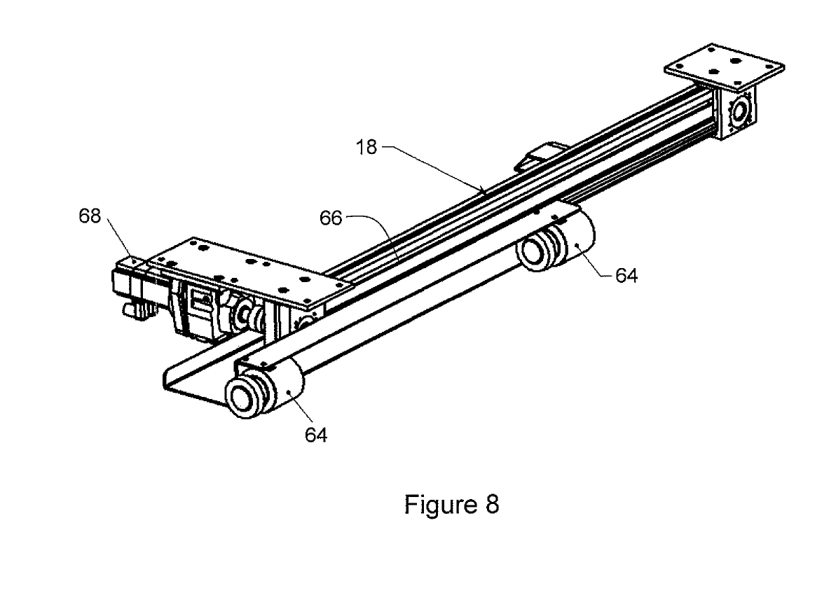

Also as described, the scanner 18 determines a position of the bin 14 relative to the mobile bin cleaning apparatus 11. In an embodiment, the scanner 18 is shown in further detail in FIG. 8 as two spaced apart laser scanners 64 mounted on a movable track 66. In the embodiment, the laser scanners 64 are arranged to determine a position of the bin 14 in three planes to determine a three-dimensional profile of the bin 14 so that it can be retained and moved accordingly. In an example, the two spaced apart laser scanners 64 are moved along the movable track 66 by a motor 68 so that the scanners 64 can be located approximately perpendicular to the bin 14 being scanned. In one example, the operator may operate the motor 68 to locate the laser scanners 64 perpendicular to the bin 14 using a CCTV camera located on the mobile bin cleaning apparatus 11. In another example, the laser scanners 64 detect when they are approximately perpendicular to the bin 14 and control the motor 68 to move accordingly.

In another embodiment, the mobile bin cleaning apparatus 11 includes a safety scanner (not shown) adjacent the base 62 of the arm 16. The safety scanner monitors a designated area around the arm 16 whilst the arm 16 is in operation to monitor unauthorised entry into this area to potentially prevent injury and/or damage to the mobile bin cleaning apparatus 11. For example, if unauthorised entry is determined by the safety scanner, movement of the arm 16 is stopped.

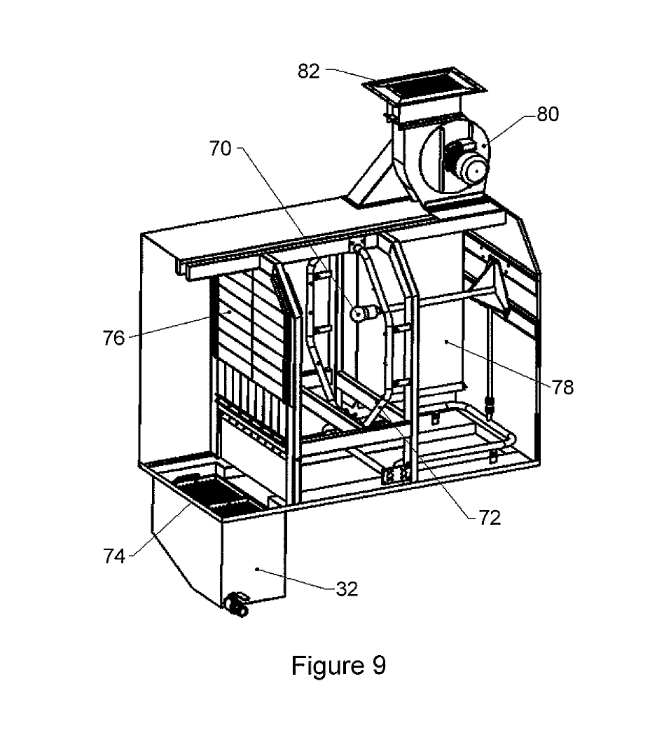

As described, the cleaning module 12 includes a cleaning chamber 13 arranged to receive the bin 14 at least partially therewithin in the second position. In the embodiment shown in FIG. 9, the cleaning module 12 including a rotary spray nozzle 70 for spraying cleaning fluid inside the bin to clean the bin and a plurality of nozzles 72 arranged circumferentially around the bin in a ring to clean the outside of the bin with cleaning fluid. It will be appreciated by those skilled in the art that in use the cleaning fluid is pumped from the tank 33 using a pump (not shown) and that the cleaning fluid is emitted from the nozzles at high pressure. For example, the pump may be arranged to emit pressurised fluid at 20,000 kPa at 139 litres of fluid per minute from the nozzles 70 & 72 to clean the bin 14. Thus, a bin may be cleaned between 20 and 30 seconds. It will be appreciated by those persons skilled in the art that the time required to clean a bin will vary accordingly to the size of the bin and will be reduced with increased efficiency of the system (e.g. more efficient processing of determined position information). Once the bin 14 is moved to the second position, the arm controller 20 outputs a command to the pump to start the wash cycle and pump cleaning fluid through the nozzles 70 & 72 to spray the inside and outside surfaces of the bin 14 received in the cleaning chamber 13 to clean the bin 14.

In the embodiment shown in FIG. 9, the sprayed cleaning fluid is collected in the sump 32 and any large pieces of rubbish dislodged by the sprayed cleaning fluid are collected by a filter grate 74. Also, the cleaning module 12 includes flaps 76 to minimise overspray from the nozzles 70 & 72. Furthermore, to further reduce overspray and mist generated by the high pressure spray nozzles from escaping the cleaning chamber 13, the mist is collected by an exhaust duct 78 which, in turn, passes it to an exhaust fan 80 and out an exhaust 82 mounted on top of the mobile bin cleaning apparatus 11 to prevent mist escaping through the front opening of the cleaning chamber 13.

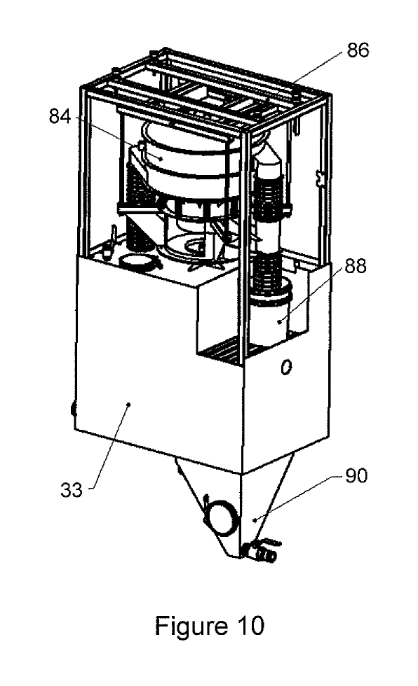

In the embodiment shown in FIG. 10, the filtering means 30 includes a vibrational sieve 84 arranged to remove solids up to 100 microns in size and a gimbal 86 arranged to ensure that the sieve remains level during operation. As described, the filtered fluid returns to the tank for re-use and the solid waste is collected in a bucket 88, which can then be disposed of by an operator using an approved practice. In addition, the tank 33 has a sediment collection and removal system 90 located at the bottom of the tank 33 to remove sediment. Also, the tank 33 has a plurality of baffles (not shown) to reduce surge in fluid pressure for the nozzles 70 & 72 and to assist mixing of detergent, disinfectant, and/or ozone, in the tank 33.

Referring now to FIG. 13, an exemplary method 300 of manipulating objects in the form of bins is summarised. The method 300 includes the steps of scanning 310 a bin in a first position to obtain position data indicative of the bin in the first position, generating 320 orientation instructions from the obtained position data for reorienting a manipulation arm from a first orientation corresponding to engagement of the bin by the arm when the bin is in the first position to a second orientation corresponding to engagement of the bin by the arm when the bin is in the second position, and controlling 330 the arm to manipulate the bin from the first position to the second position based on the orientation instructions.

In the embodiment shown in FIG. 11, the ozone generator 34 includes a number of components used to generate ozone and mix it with fluid stored in the tank 33 to sanitise the stored fluid in the tank 33 and to sanitise the bin 14. The ozone generator 34 includes an oxygen generator 92 and an ozone generator 94, such as a coronal discharge chamber, which passes an electrical charge over the oxygen enriched air from the oxygen generator 92 to create oxygen radicals to combine with oxygen atoms to form ozone. The level of ozone produced is monitored by a controller 96 and once a sufficient level is generated the ozone gas is drawn into the cleaning fluid via an injector valve 98. The ozone passes though the valve 98 into a contact chamber 100 which includes piping and inline mixers 102 arranged to cause effective homogenisation (i.e. minimisation of the size of the ozone gas bubbles formed through absorption in water). For example, the contact chamber 100 includes eighteen metres of coiled section of pipe to enable sufficient mix creating turbulence in the pipe and three inline mixers 102. The mixed ozone and water is then passed into the tank 33 via a flow switch 104 using a recirculation pump 106. Also, the ozone generator 34 also includes a bypass valve 108 to bypass the addition of ozone to the fluid if excess ozone is detected by sensors (not shown).

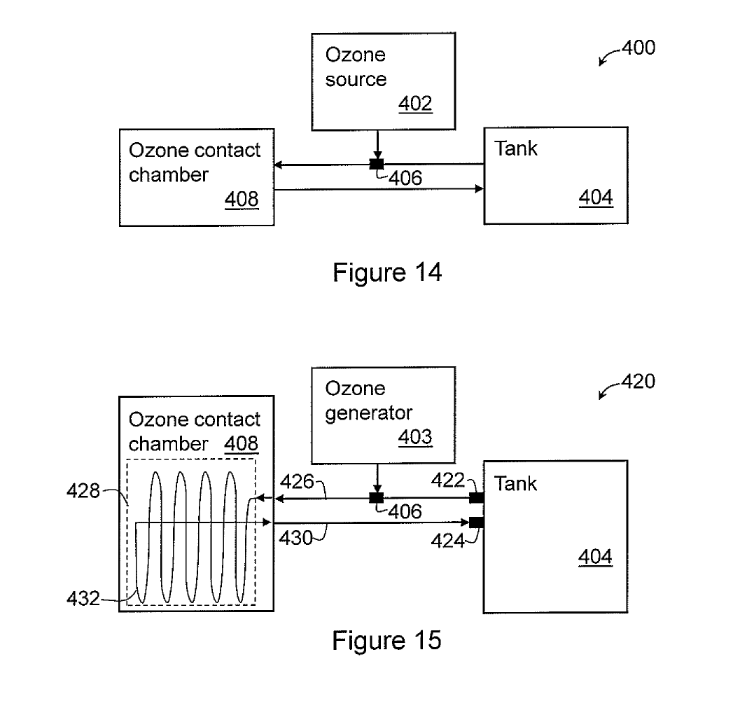

As described, the ozone generator 34 of FIG. 11 is an exemplified embodiment of a system and method of ozonation. This system is shown as is ozonation system 400 in FIG. 14 and comprises an ozone source 402 for providing ozone gas for transfer into a liquid retained in a tank 404, as shown in FIG. 14. The system 400 also comprises an ozone injector 406 for injecting the ozone gas received from the ozone source 402 into an influent stream received from the tank 404, and an ozone contact chamber 408 receiving the influent stream with the ozone gas, contacting the ozone gas with the liquid of the influent stream so that the ozone gas can be transferred into the liquid, and outputting the liquid from the contact chamber 408 with the ozone gas transferred therein into an effluent stream to be returned to tank 404. In the embodiment, the ozone contact chamber 408 comprises a plurality of successive contact chamber portions 428 (shown in FIG. 15) through which said influent stream passes to generate turbulence in the liquid in the contact chamber portions 428.

As described, the ozonised liquid is used with respect to an object to treat and/or disinfect the object. For example, the object is a bin and ozonised water is used to clean and disinfect the bin. Furthermore, in an embodiment, the system 400 comprises a vehicle comprising the ozone source 402 in the form of an ozone generator 403 (shown in FIG. 11), the ozone injector 406, the ozone contact chamber 408 and the tank 404. In the example, the vehicle could be located adjacent the bin to be clean the bin with ozonised water and at least a portion of the sprayed ozonised water is returned to the tank 404 after being used. As described, the ozonised water can be used to disinfect, and/or lower bio-burden levels present in, the bin by oxidising many organic and inorganic compounds located on the surfaces of the bin. However, some organic and inorganic compounds may be dislodged but not completely oxidised by the ozone. In this case, the used water, along with any residue, is returned to the tank 404 and the ozone present in the water in the tank oxidises any remaining compounds. It will be appreciated by those persons skilled in the art that the tank 404 comprises a sump (not shown) and a filter (not shown) to collect and prevent residue from entering the water in the tank 404.

FIG. 15 shows an ozonation system 420 in further detail including a number of components used to contact generated ozone gas with water from the tank 404 and transfer it thereto. It can be seen that the tank 404 comprises an inlet 424 and an outlet 422 for admitting the effluent stream 430 and releasing the influent stream 426 thereto and therefrom the tank 404 to the ozone contact chamber 408. Furthermore, the ozone contact chamber 408 comprises the plurality of successive contact chamber portions 428 having a plurality of elongate coils of pipe 432 aimed at ensuring adequate contact and/or residence time for the ozone gas in the liquid.

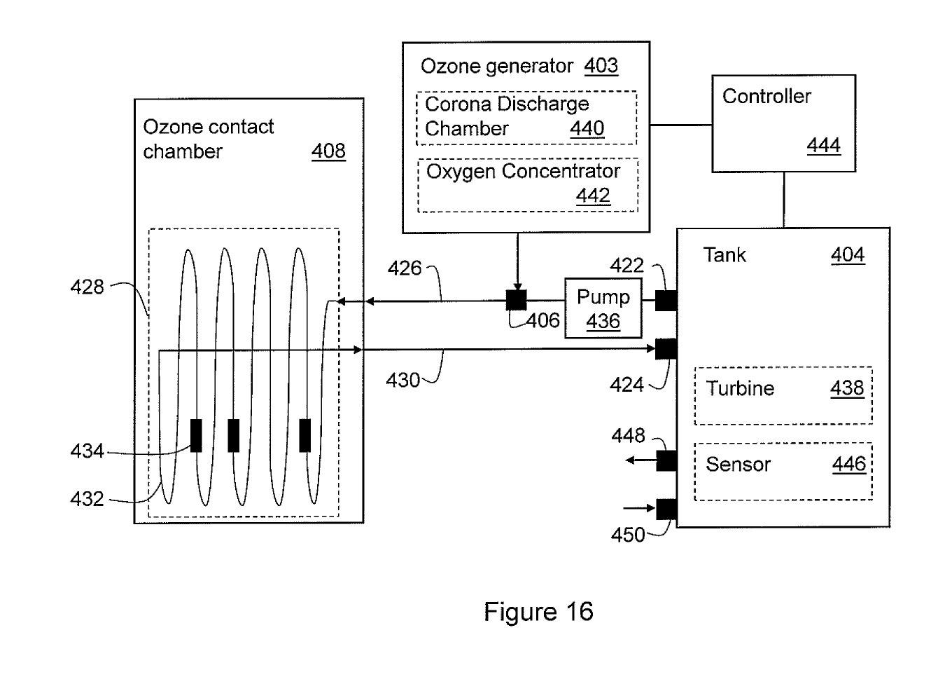

In addition, some of the coils of pipe 432 in the ozone contact chamber 408 have inline mixers 434 (e.g. mechanical mixing nozzles) to further enhance the turbulence of flow through the plurality of successive contact chamber portions 428 to reduce bubble size of the ozone gas. It can be seen from FIG. 16 that there are three inline mixers 434 arranged to force the influent stream 426 of water and partially dissolved ozone gas through the successive coils of pipe 432 of the ozone contact chamber 408. As described, the inline mixers 434 comprise a rotor to draw the influent stream through the inline mixer 434 and a stator to disperse the gas bubbles and reduce their size to increase their contact area.

The inline mixers 434 ensure adequate mass transfer of the ozone and its contact with water, in a bulk water phase, by successively reducing the bubble size of the ozone gas in the water of the influent stream 426. That is, the ozone contact chamber 408 receives an influent stream comprising ozone gas partially dissolved in the liquid and reduces the bubble size of the undissolved ozone gas, successively in each chamber, by action of the mixers 434 to increase its contact area and thus increase its transfer into the liquid. In an example, the influent stream 426, including partially dissolved ozone gas injected via the injector 406, is forced through the plurality of coils 432 under turbulent flow to successively generate turbulence and passes through the mixers 434 to reduce bubble size of the ozone gas which passes through the coils 432, so that it can be more readily transferred (e.g. dissolved) into the water.

In an embodiment, there are 12 elongate coils of pipe each having an elongate length of 1500 mm thus providing a length of 18 metres of pipe for the successive contact chamber portions 428. It will be appreciated by those persons skilled in the art that this configuration enables the contact chamber 408 to be compact and adapted to be disposed in a mobile apparatus, such as a vehicle, along with the tank 404. It will be appreciated that other such compact and readily portable configurations could be implemented such as having 15 coils with elongate lengths of 1000 mm. Also, the diameter of the pipes can be designated based on the size of the tank 404, desired transfer rate of ozone gas into water, desired concentration of ozone gas in the water, etc.

The influent stream 426, including partially dissolved ozone gas injected via the injector 406, is forced through the plurality of coils 432 under turbulent flow via a pump 436 shown in FIG. 16. As described, the pump pressurises the influent stream 426 to create the turbulent flow through the ozone contact chamber 408 and to draw in the generated ozone gas from the injector 406. Although not shown, it will be appreciated by those persons skilled in the art that the pump 436 may be a recirculation pump arranged to pump both water from the tank 404 to the ozone contact chamber 408 and to pump ozonised water from the ozone contact chamber 408 back into the tank 404.

FIG. 16 shows an ozonation system for transferring ozone gas into water having a controller 444 arranged to receive information from sensors to monitor and control generation of ozonised water. The controller 444 is in data communication with a sensor 446 (to control generation of ozone gas by the ozone generator 403 based on a sensed concentration of dissolved ozone in the water in the tank 404. As described, the sensor 446 may be an ORP sensor arranged to sense dissolved oxygen and, in this case, the controller 444 is further arranged to determine the concentration of ozone dissolved in the water from this measurement. The controller 444 can then control generation of ozone gas by the ozone generator 403 accordingly.

The ozone generator 403 is also shown in FIG. 16 comprising a corona discharge chamber 440 arranged to form ozone gas from received oxygen via an oxygen concentrator 442 to enrich the oxygen content of the received air. As described, the corona discharge chamber 440 comprises two spaced apart electrodes having a voltage applied thereto causing electrons to flow across the discharge gap of the corona discharge chamber 440 to provide the energy required to disassociate oxygen molecules (O₂) of the received oxygen enriched air from the oxygen concentrator 442 to form ozone. In addition, the use of an air conditioner (not shown) further enhances the formation of ozone using the corona discharge chamber 440.

As described, the ozonised water in the tank 404 is used with respect to an object to clean the object, such as cleaning and disinfecting a bin, and FIG. 16 shows the tank 404 having an outlet 448 to output the ozonised water and an inlet 450 to receive at least a portion of the outputted ozonised water after it is used with respect to cleaning the bin. It will be appreciated by those skilled in the art that the system need not be a closed loop system and the inlet 450 may input clean water to refill the tank 404 in addition to returning at least a portion of the outputted water.

Referring back to FIG. 11, there is shown an ozonation system 36 in a configuration for use with a mobile apparatus having the features described above. It can be seen that the tank 33 has a recirculation pump 106 attached thereto via the outlet 114 and the inlet (not shown) of the tank 33. The pump 106 has a strainer (e.g. a 100 micron strainer) to protect the pump from inflow of particles and is connected to a safety valve on the outlet side 114 to prevent water from the tank 33 entering the contact chamber 100 if required. The tank 33 is connected to the contact chamber 100, via the pump 106, via piping to communicate the influent and effluent streams of water, and includes a series of valves and gauges control and monitor flow of the water. The valves include the safety valve described above, a bypass valve 108 to bypass ozone gas injection via the ozone injector into the is influent stream, and a flow valve 104 to control flow of ozonised water back into to the tank 33. The tank 33 also shows the inlet 118 and the outlet 116 for using of the ozonised liquid contained in the tank 33 to clean a bin.

In addition, it can be seen that the tank 33 comprises a mount for the turbine 120 to mix and agitate the ozonised water in the tank 33. Also, mounted to the tank 33 is an inspection plate to inspect the contents of the tank, a refill inlet to refill the tank with water, and the sensor 122 to measure the amount of dissolved ozone (or dissolved oxygen using an ORP sensor) within the water held in the tank 33. It will be appreciated by those skilled in the art that the tank 33 may be pressurised and may sealed from atmosphere to prevent ozone gas from escaping. In addition, liquid held in the tank, other than water, may require the tank to be sealed from atmosphere, such as alcohol.

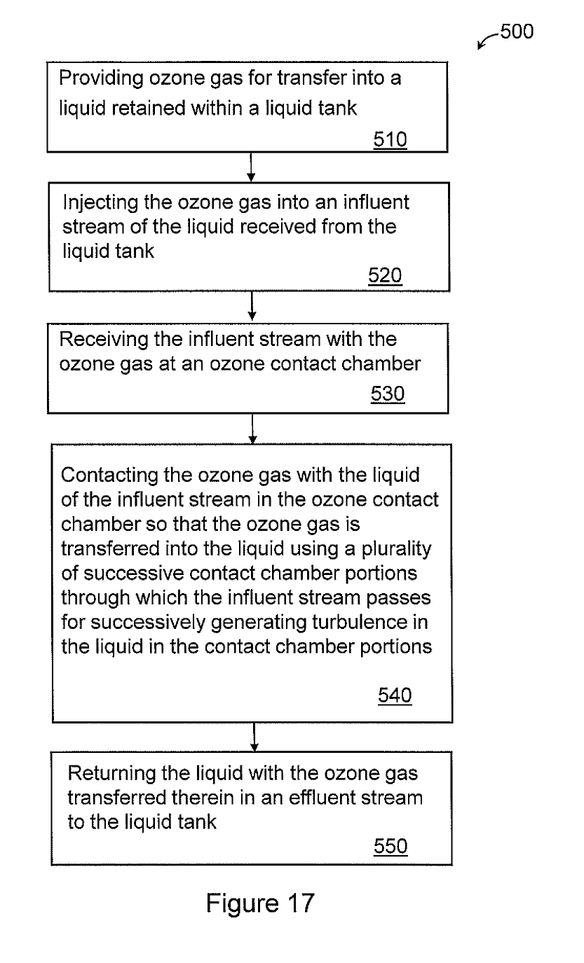

Referring now to FIG. 17, an exemplary method 500 of ozonation is summarised. The method 500 includes the steps of providing 510 ozone gas for transfer into a liquid retained within a tank, injecting 520 ozone gas into an influent stream of liquid received from the tank, receiving 530 the influent stream with the ozone gas at an ozone contact chamber, contacting 540 the ozone gas with the liquid of the influent stream in the ozone contact chamber so that the ozone gas is transferred into the liquid using a plurality of successive contact chamber portions through which the influent stream passes for successively generating turbulence in the liquid in the contact chamber portions, and outputting 550 the liquid with the ozone gas transferred therein from the ozone contact chamber into an effluent stream to be returned to the tank.

It will be understood to persons skilled in the art of the invention that many modifications may be made without departing from the spirit and scope of the invention.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A mobile bin cleaning apparatus comprising:
a cleaning module disposed in the mobile bin cleaning apparatus to clean a bin;
an arm arranged to move the bin between a first position remote from the mobile bin cleaning apparatus and a second position in which the bin can be cleaned by the cleaning module;
at least one scanner arranged to locate the bin by scanning the first position to determine a position of the bin relative to the mobile bin cleaning apparatus, by obtaining position data in the form of distance values relative to the scanner, distance being detected in more than one plane comprising at least two intersecting planes; and
a translation module arranged to receive the position data and to transform the position data into three dimensional co-ordinate data;
wherein said apparatus is configured to identify the bin within the three dimensional co-ordinate data;
said apparatus includes a manipulation module arranged to receive data indicative of the position of the bin, and to generate orientation instructions therefrom for reorienting the arm from a first orientation corresponding to engagement of said bin by said arm when said bin is in said first position to a second orientation corresponding to engagement of said bin by said arm when said bin is in the second position; and
said apparatus includes an arm controller arranged to receive the orientation instructions and to control the arm based on the orientation instructions to engage the bin and move the bin between the first and second positions.

2. A mobile bin cleaning apparatus as claimed in claim 1, wherein said apparatus is configured to identify the bin by locating a three-dimensional profile of the bin within said three dimensional co-ordinate data; and said manipulation module is arranged to receive said data indicative of the position of the bin and data indicative of said three-dimensional profile of the bin and to generate said orientation instructions therefrom.

3. A mobile bin cleaning apparatus as claimed in claim 2, configured to form the three-dimensional profile of the bin using known profiles of bins.

4. A mobile bin cleaning apparatus as claimed in claim 1, wherein the at least one scanner comprises two spaced-apart laser scanners, configured to scan the bin in intersecting planes.

5. A mobile bin cleaning apparatus as claimed in claim 4, wherein the spaced-apart laser scanners scan at opposed 15 degree angles to the perpendicular and/or the apparatus scans the bin by moving the spaced-apart laser scanners together relative to the bin while each of the spaced-apart laser scanners performs a scan of the bin.

6. (canceled)

7. A mobile bin cleaning apparatus as claimed in claim 1, wherein the arm comprises any one or more of:
i) six degrees of freedom of movement;
ii) an articulated robotic arm;
iii) a gripper to retain the bin;
iv) at least one suction cup to retain the bin; and
v) a gripper that has two degrees of freedom of movement to retain the bin.

8. A mobile bin cleaning apparatus as claimed in claim 1, wherein the arm comprises at least one bellow type or other suction cup to retain the bin, and the apparatus comprises a vacuum means arranged to create a partial vacuum between the least one bellow type or other suction cup and the surface of the bin, for maintaining suction between the at least one bellow type or other suction cup and the surface of the bin.

9. (canceled)

10. A method for cleaning bins comprising:
locating a mobile bin cleaning apparatus adjacent a bin in a first position;
locating the bin in the first position by scanning with a scanner to determine a position of the bin relative to the mobile bin cleaning apparatus by obtaining position data in the form of distance values relative to the scanner, distance to the bin being detected in more than one plane comprising at least two intersecting planes;
processing the position data by transforming the position data into three dimensional co-ordinate data;
identifying the bin within the three dimensional co-ordinate data;
generating, with a manipulation module, orientation instructions from data indicative of the position of the bin for reorienting an arm from a first orientation corresponding to engagement of said bin by said arm when said bin is in said first position to a second orientation corresponding to engagement of said bin by said arm when said bin is in a second position in which the bin can be cleaned in a cleaning module disposed in the mobile bin cleaning apparatus, and outputting said orientation instructions to an arm controller;
controlling the arm, with the arm controller, to engage the bin when the bin is in the first position and to move the bin from the first position to the second position, based on the orientation instructions;
cleaning the bin with the bin cleaning module; and
controlling the arm, with the arm controller, to move the bin from the second position to a position remote from the mobile bin cleaning apparatus.

11. A method as claimed in claim 10, including identifying the bin by locating a three-dimensional profile of the bin within said three dimensional co-ordinate data, and generating said orientation instructions with said manipulation module from said data indicative of the position of the bin and data indicative of the three-dimensional profile of the bin.

12. A method as claimed in claim 11, comprising forming the three-dimensional profile of the bin including using known profiles of bins.

13. A method as claimed in claim 10, wherein the scanner comprises two spaced-apart laser scanners, configured to scan the bin in intersecting planes.

14. Computer program code which when executed implements a method of cleaning bins, the method comprising:
locating a bin in a first position by scanning with a scanner to determine a position of the bin relative to a mobile bin cleaning apparatus by obtaining position data in the form of distance values relative to the scanner, distance to the bin being detected in more than one plane comprising at least two intersecting planes;
processing said position data by transforming the position data into three dimensional co-ordinate data;
identifying the bin within the three dimensional co-ordinate data;
generating, with a manipulation module, orientation instructions from data indicative of the position of the bin for reorienting an arm from a first orientation corresponding to engagement of said bin by said arm when said bin is in said first position to a second orientation corresponding to engagement of said bin by said arm when said bin is in a second position in which the bin can be cleaned in a cleaning module disposed in the mobile bin cleaning apparatus, and outputting said orientation instructions to an arm controller; and
controlling the arm, with the arm controller, to engage the bin when the bin is in the first position and to move the bin from the first position to the second position, based on the orientation instructions;
cleaning the bin with the bin cleaning module; and
controlling the arm, with the arm controller, to move the bin from the second position to a position remote from the mobile bin cleaning apparatus.

15. Computer program code as claimed in claim 14, wherein said method includes identifying the bin by locating a three-dimensional profile of the bin within said three dimensional co-ordinate data, and generating said orientation instructions with said manipulation module from said data indicative of the position of the bin and data indicative of the three-dimensional profile of the bin.

16. Computer program code as claimed in claim 15, wherein the method comprises forming the three-dimensional profile of the bin using known profiles of bins.

17. An arm controller for controlling an arm, wherein the arm controller is arranged to:
receive information from a scanner indicative of a position of an object when said object is in a first position; and
control the arm based on the information received from the scanner to engage the object when in the first position and to move the object from the first position to a second position;
wherein the information from the scanner is determined from position data in the form of distance values to a surface of the object, distance to the object having been detected in more than one plane comprising at least two intersecting planes, transformed into three dimensional co-ordinate data and used to identify the object within the three dimensional co-ordinate data.

18. An arm controller as claimed in claim 17, wherein the information from the scanner is also indicative of a three-dimensional profile of the object identified within the three dimensional co-ordinate data.

19. A system for manipulating objects comprising:
an optical scanner arranged to locate an object in a first position by obtaining position data indicative of said first position in the form of distance values relative to the scanner, distance to the object being detected in more than one plane comprising at least two intersecting planes; and
a translation module arranged to receive the position data and to transform the position data into three dimensional co-ordinate data;
wherein said system is configured to identify the object within the three dimensional co-ordinate data;
said system includes a manipulation module arranged to receive data indicative of the position of the object, and to generate orientation instructions therefrom for reorienting a manipulation arm from a first orientation corresponding to engagement of said object by said arm when said object is in said first position to a second orientation corresponding to engagement of said object by said arm when said object is in a second position; and
said system includes an arm controller arranged to receive the orientation instructions and to control the manipulation arm to manipulate the object from the first position to the second position based on the orientation instructions.

20. A system as claimed in claim 19, wherein said system is configured to identify the object by locating a three-dimensional profile of the object within said three dimensional co-ordinate data; and said manipulation module is arranged to receive said data indicative of the position of the object and data indicative of said three-dimensional profile of the object and to generate said orientation instructions therefrom.

21. A system as claimed in claim 20, configured to form the three-dimensional profile of the object using known object profiles.

22. A system as claimed in claim 19, wherein the scanner comprises two spaced-apart laser scanners, configured to scan the object in intersecting planes.

23. A system as claimed in claim 19, wherein the second position is either predefined or determined, at least in part, according to an identification of the object.

24. (canceled)

25. A system as claimed in claim 19, wherein the arm controller is further arranged to control the manipulation arm for translational manipulation of the object from the first position to the second position based on the orientation instructions, or to control the manipulation arm for rotational manipulation of the object from the first position to the second position based on the orientation instructions.

26. A system as claimed in 19, further comprising:
i) a cleaning module for cleaning the object when in the second position;
ii) a bomb disposal module for disposing of the object when in the second position; or
iii) an operating module arranged to perform an operation associated with the object in the second position.

27. (canceled)

28. A vehicle or other mobile apparatus, comprising a system as claimed in claim 19, further comprising said manipulation arm.

29. A method of manipulating objects comprising:
locating an object in a first position by optical scanning with a scanner to obtain position data indicative of said first position in the form of distance values relative to the scanner, distance to the object being detected in more than one plane comprising at least two intersecting planes;
processing the position data by transforming the position data into three dimensional co-ordinate data;
identifying the object within the three dimensional co-ordinate data;
generating orientation instructions from data indicative of the position of the object for reorienting a manipulation arm from a first orientation corresponding to engagement of said object by said arm when said object is in said first position to a second orientation corresponding to engagement of said object by said arm when said object is in a second position; and
controlling the manipulation arm to engage the object and to manipulate the object from the first to the second position based on the orientation instructions.

30. A method as claimed in claim 29, including identifying the object by locating a three-dimensional profile of the object within said three dimensional co-ordinate data, and generating said orientation instructions from said data indicative of the position of the object and data indicative of the three-dimensional profile of the object.

31. Computer program code which when executed implements a method of manipulating objects comprising:
locating an object in a first position by optical scanning with a scanner to obtain position data indicative of said first position in the form of distance values relative to the scanner, distance to the object being detected in more than one plane comprising at least two intersecting planes;
processing the position data by transforming the position data into three dimensional co-ordinate data;
identifying the object within the three dimensional co-ordinate data;
generating orientation instructions from data indicative of the position of the object for reorienting a manipulation arm from a first orientation corresponding to engagement of said object by said arm when said object is in said first position to a second orientation corresponding to engagement of said object by said arm when said object is in a second position; and
controlling the manipulation arm to engage the object and to manipulate the object from the first to the second position based on the orientation instructions.

32. A system for manipulating objects comprising:
a scanner arranged to optically scan an intended location for placement of an object in a first position by obtaining position data indicative of said first position in the form of distance values relative to the scanner, distance to the intended location being detected in more than one plane comprising at least two intersecting planes;
a translation module arranged to receive the position data and to transform the position data into three dimensional co-ordinate data;
a manipulation module arranged to receive the position data and to generate orientation instructions therefrom for reorienting a manipulation arm from a first orientation corresponding to engagement of said object by said arm when said object is in a second position to a second orientation corresponding to engagement of said object by said arm when said object is in said first position; and
an arm controller arranged to receive the orientation instructions and to control the manipulation arm to manipulate the object from the second position to the first position based on the orientation instructions.

33-56. (canceled)
